(19) United States
(12) Patent Application Publication
(10) Pub. No.: US 2011/0168120 A1
(43) Pub. Date: Jul. 14, 2011

(54) Modular Cross-Ram High Performance Intake Manifold for V-Type Multi-Cylinder Internal Combustion Engines

(76) Inventors: Brenda BRUMAN, Shelby Twp, MI (US); Marcello Tedesco, Shelby Twp, MI (US)

(21) Appl. No.: 13/004,410

(22) Filed: Jan. 11, 2011

Related U.S. Application Data
(60) Provisional application No. 61/293,958, filed on Jan. 11, 2010.

(51) Int. Cl. F02M 35/116

(52) U.S. Cl. 123/184.35

(57) ABSTRACT

A modular intake manifold system that allows different assembly embodiments enabling different ramming effects for a V type multi-cylinder internal combustion engine. The present invention comprises a uniquely shaped runner manifold and plenum chambers for optimized airflow.

The current application claims a priority to the U.S. Provisional Patent application Ser. No. 61/293,958 filed on Jan. 11, 2010.

### FIELD OF THE INVENTION

The present invention relates generally to a uniquely designed intake manifold. More specifically, the present invention makes use of two uniquely shaped plenums and intake runners for efficient suction of air.

### BACKGROUND OF THE INVENTION

Traditionally, most internal combustion engines in vehicles make use of a single plenum and a single throttle body for the suction and distribution of air. A single plenum and throttle body is generally sufficient in the suction and distribution of air for functionality. Many intake manifolds have been developed with different shapes and sizes to increase air flow efficiency. Air flow efficiency is directly related to the resistance the air experiences when travelling through enclosed spaces such as pipes. The characteristics of the piping on intake manifolds that may add air flow resistance are bends and turns. Additionally, traditionally combustion engines make use of intake manifolds that have a single throttle body for the intake of air. The present invention is a modular cross-ram high performance intake manifold for a V type multi cylinder internal combustion engine including a set of intake runners which communicate with each opposed cylinder head bank. The intake manifold of the present invention makes use of dual plenum chambers with a throttle body for each chamber. The use of dual plenum chambers allows for a more even distribution of air and to equalize intake runner velocity. The design of the present invention ensures equal air to fuel ratio for each cylinder of an engine for efficient performance. The independent left and right intake runners provide the dynamic effect of intake air between each cylinder bank. The present invention is arranged in such a manner to provide different configurations for the ramming effect or intake of air into each opposed cylinder head. The various elements of the present invention can be arranged in different configurations to create individual cross-ram high performance intake manifold systems.

### BRIEF DESCRIPTION OF THE DRAWINGS

FIG. 1 is a perspective view of the preferred embodiment of the present invention with two plenum chambers with a throttle body for each chamber.

FIG. 2 is a right side elevational view of the preferred embodiment of the present invention with two plenum chambers.

FIG. 3 is a left side elevational view of the preferred embodiment of the present invention with two plenum chambers.

FIG. 4 is a rear elevational view of the preferred embodiment of the present invention with two plenum chambers.

FIG. 5 is the bottom plan view of the preferred embodiment of the present invention with two plenum chambers.

FIG. 6 is a cross sectional view showing the internal runner channel of a LH runner.

FIG. 7 is a cross sectional view showing the internal runner channel of a RH runner. The present invention is shown being connected to a V-type multi-cylinder engine.

FIG. 8 is a perspective view of another embodiment of the present invention with two plenum chambers. The two plenum chambers are able to share a common throttle body by means of a Y-pipe. The Y-pipe is shown detached from two plenum chambers without the throttle body.

FIG. 9 is a front elevational view of another embodiment of the present invention without any plenum chambers. The plurality of RH runners and the plurality of LH runner are directly connected to the plurality of RH venturi stacks and the plurality of LH venturi stacks. In this embodiment, the RH venturi stacks and the plurality of LH venturi stacks are short.

FIG. 10 is a perspective view of another embodiment of the present invention without any plenum chambers. The plurality of RH runners and the plurality of LH runner are directly connected to the plurality of RH venturi stacks and the plurality of LH venturi stacks. In this embodiment, the RH venturi stacks and the plurality of LH venturi stacks are short.

FIG. 11 is a perspective view of another embodiment of the present invention without any plenum chambers. The plurality of RH runners and the plurality of LH runner are directly connected to the plurality of RH venturi stacks and the plurality of LH venturi stacks. In this embodiment, the RH venturi stacks and the plurality of LH venturi stacks are long.

FIG. 12 is a rear elevational view of another embodiment of the present invention without any plenum chambers. The plurality of RH runners and the plurality of LH runner are directly connected to the plurality of RH venturi stacks and the plurality of LH venturi stacks. In this embodiment, the RH venturi stacks and the plurality of LH venturi stacks are long.

FIG. 13 is a cross sectional view of the embodiment of the present invention where the plurality of venturi stacks for the RH and the LH are both directly connected to the plurality of runners showing the throttle body positioned in line with the runner channels.

### DETAIL DESCRIPTIONS OF THE INVENTION

All illustrations of the drawings are for the purpose of describing selected versions of the present invention and are not intended to limit the scope of the present invention.

The present invention is a modular intake manifold assembly system designed for V-type engines with multiple cylinders that can be arranged in different configurations to achieve a number of different ramming effects. In order to create different ramming effects, the present invention comprises of a RH plenum chamber 1, a LH plenum chamber 2, a runner manifold 3, at least one throttle body 6, a plurality of fuel injectors 7, a fuel supply line 8, fuel rail brackets 10, a pair fuel injector rails 9, a plurality of cylinder head gaskets 30, a plenum chamber tube 40, at least one mass flow sensor 50, a manifold absolute pressure sensor 60, and an engine oil fill extension 70. The RH plenum chamber 1 and the LH plenum chamber 2 are pressurized housings that supplies air to the cylinders of an engine. The RH plenum chamber 1 and the LH plenum chamber 2 are pressurized with air by means of suction and vacuum. To direct the pressurized air into the plurality of cylinders of an engine, the present invention makes use of the runner manifold 3. The runner manifold 3 makes use of individual channels to direct the pressurized gas into the cylinder head of an engine. To control the amount of air flow into the RH plenum chamber 1 and the LH plenum chamber 2, the present invention makes use of the at least one throttle bodies. The throttle bodies comprise of butterfly valves that decreases the amount of area of the throttle body in which air can by pass. In addition to the air intake system, the present invention also has an integrated fuel injection system including the plurality of fuel injectors 7, the fuel supply line 8, the fuel rail brackets, and the pair of fuel injector rails 9. To ensure the intake system injects the correct fuel to air ratio into the cylinders of the engine, the present invention relies on at least one mass flow sensor 50 and the manifold absolute pressure sensor 60. The use of the components in different configurations allows the present invention to achieve different ramming effects for different performance results.

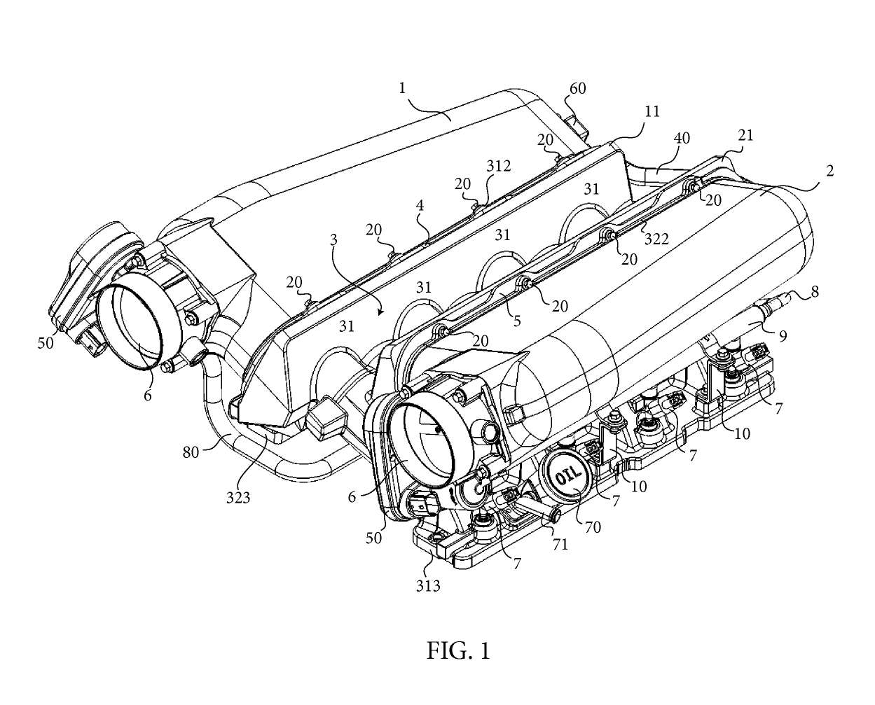

In references to FIG. 1, the runner manifold 3 comprises of a plurality of RH intake runners 31 and a plurality of LH intake runners 32. The plurality of RH intake runners 31 and the plurality of LH intake runners 32 are downwardly bending hollow tube channels. With minimal amount of distortion to the intake runners, the air flow is not restricted and is able to deliver air to the cylinders efficiently. The plurality of RH intake runners 31 and the plurality of LH intake runners 32 are connected and arranged in an alternating crisscross fashion giving the runner manifold 3 an X-shape. The plurality of RH intake runners 31 having first RH ends and second RH ends comprises a RH chamber flange 312, a plurality of RH runner channels 311, a RH cylinder opening, a RH cylinder flange 313, and a plurality of RH intake runner stack openings 314. The plurality of LH intake runners 32 having first LH ends and second LH ends comprises a LH chamber flange 322, a plurality of LH runner channel, a LH cylinder opening, a LH cylinder flange 323, and a plurality of LH intake runner stack openings 324. The RH chamber flange 312 is positioned on the first RH ends. The LH chamber flange 322 is positioned on the first LH ends. The plurality of RH runner channels 311 are funnel shaped channels that traverse through the first RH ends in line with the plurality of RH intake runners 31. The plurality of LH runner channels 321 are funnel shaped channels that traverse through the first LH ends in line with the plurality of LH intake runners 32. The plurality of RH intake runner stack openings 314 is the openings of the runner manifold 3 leading into the plurality of RH runner channels 311. The plurality of LH intake runner stack openings 324 is the openings of the runner manifold 3 leading into the plurality of LH runner channels 321. The RH cylinder flange 313 is positioned on the second RH ends of the plurality of RH intake runners 31. The LH cylinder flange 323 is positioned on the second LH ends of the plurality of LH intake runners 32. The RH cylinder flange 313 is a flat plate that extends around the second RH ends that allow the plurality of RH intake runners 31 to be connected to the RH cylinder heads. The LH cylinder flange 323 is a flat plate that extends around the second LH ends that allow the plurality of LH intake runners 32 to be connected to the LH cylinder heads.

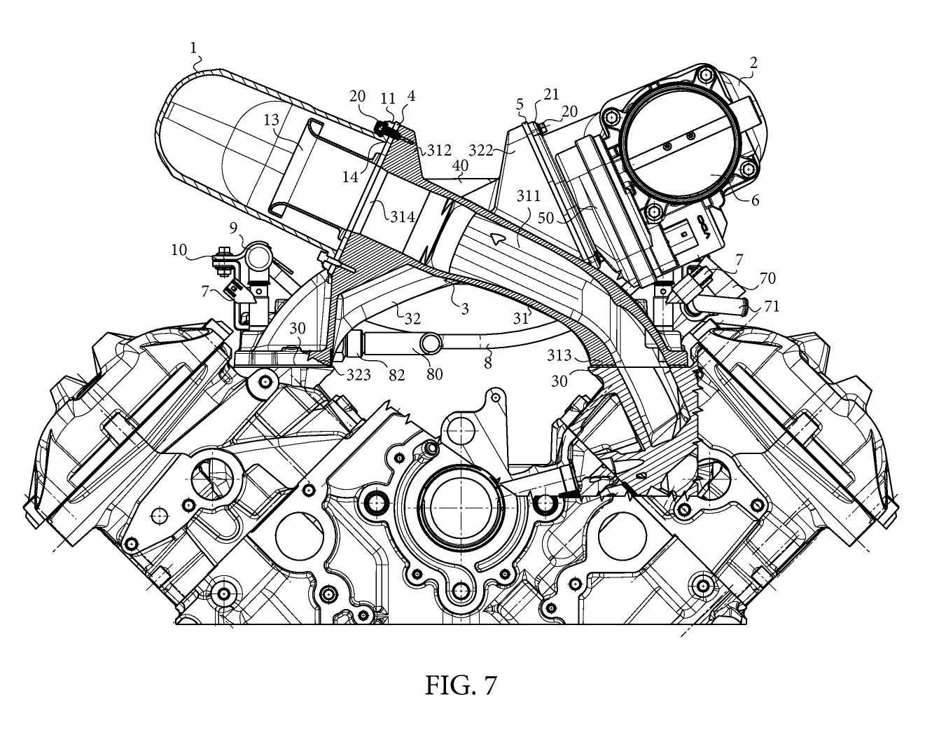

In reference to FIG. 1 and FIG. 6-7, the preferred assembly of the present invention includes the use of plenum chambers to ensure even air distribution among all of the cylinders of an engine. The RH plenum chamber 1 comprises a RH runner flange 11, a RH intake opening 12, a plurality of RH venturi stacks 13, and a RH runner opening 14. The LH plenum chamber 2 comprises a LH runner flange 21, a LH intake opening 22, a plurality of LH venturi stacks 23, and a LH runner opening 24. The RH plenum chamber 1 being rectangular shaped has a RH front side, a RH back side, and a RH bottom side. The LH plenum also being rectangular shaped has a LH front side, a LH back side, and a LH bottom side. The RH plenum chamber 1 has rounded corners and tapers towards the RH back side. The LH plenum chamber 2 similarly has rounded corners and tapers towards the LH back side. The RH plenum chamber 1 and the LH plenum chamber 2 are hollow chambers that hold and distribute air to the cylinder heads of a V-type engine. The unique shape of the RH plenum chamber 1 and the LH plenum chamber 2 allow and ensure that each cylinder of the engine receives the same volume of air. The RH intake opening 12 is positioned on the RH front side of the RH plenum chamber 1. The LH intake opening 22 is positioned on the LH front side of the LH plenum chamber 2. The RH runner flange 11 is peripherally positioned on edges of the RH bottom side of the RH plenum chamber 1. The LH runner flange 21 is peripherally positioned on the edges of the LH bottom side of the LH plenum chamber 2. The RH runner flange 11 and the LH runner flange 21 allow the RH plenum chamber 1 and the LH plenum chamber 2 to be secured onto the runner manifold 3. Positioned along the RH bottom side and the LH bottom side are the RH runner opening 14 and the LH runner opening 24, respectively. The RH runner opening 14 and the LH runner opening 24 are large openings arranged on the RH bottom side and the LH bottom side, respectively. The RH runner opening 14 and the LH runner opening 24 are holes that lead into the plenum chambers. The plurality of RH venturi stacks 13 are funnel shaped structures that are connected and positioned inside the RH plenum chamber 1. The plurality of RH venturi stacks 13 align to the each of the RH intake runner stack openings of the runner manifold 3. The plurality of LH venturi stacks 23 is similarly funnel shaped structures that are connected and positioned inside the LH plenum chamber 2. The plurality of LH venturi stacks 23 align to each of the LH intake runner stack openings of the runner manifold 3.

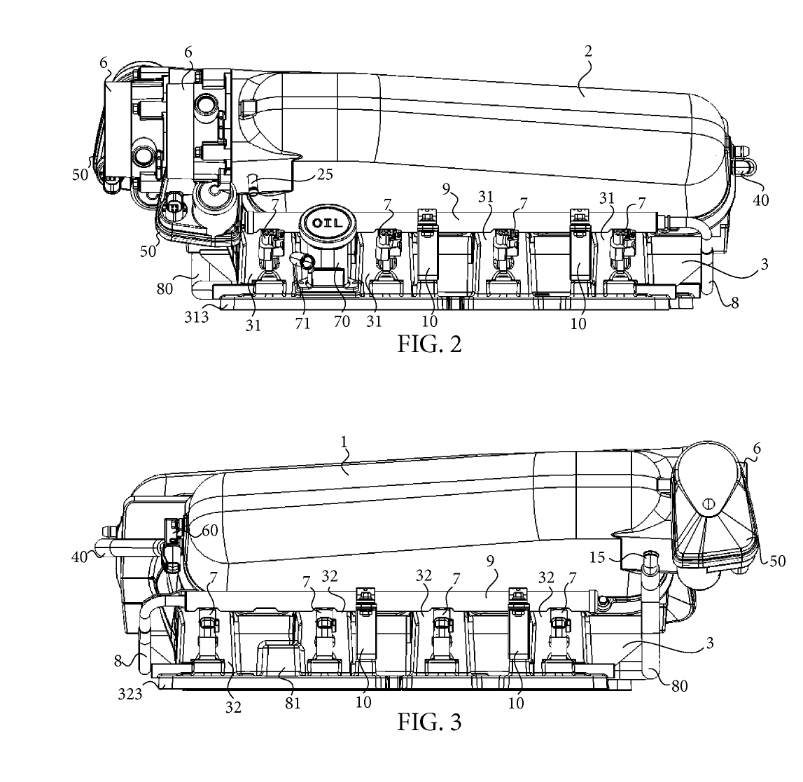

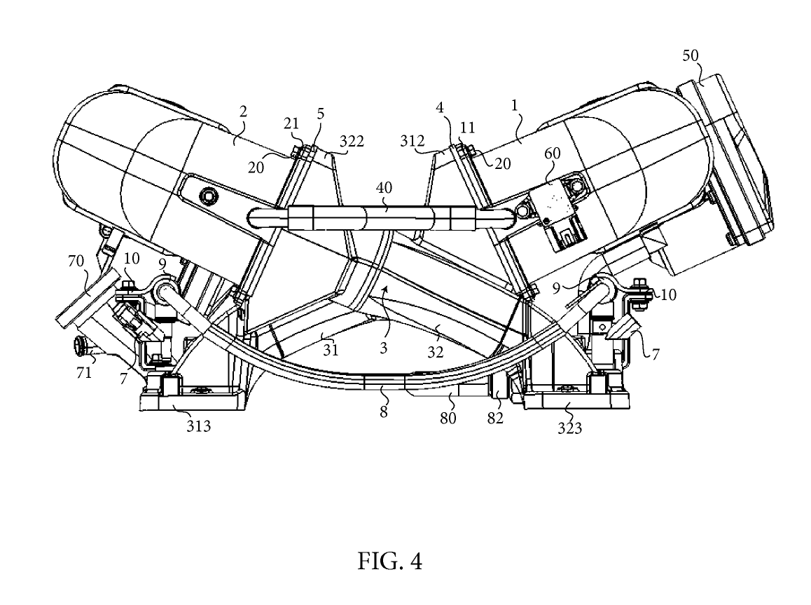

In reference to FIG. 2-7, to complete the assembly of the present invention, involves the connection of the plenum chambers to the runner manifold 3. First, the plurality of RH venturi stacks 13 are aligned and connected to each of the plurality of RH intake runner stack openings 314 by the fasteners 20. The plurality of LH venturi stacks are aligned and connected to each of the plurality of LH intake runner stack openings 324 by the fasteners 20. The RH plenum chamber 1 cups over the plurality of RH venturi stacks 13 and is connected to the plurality of RH intake runners 31 by the connection of the RH runner flange 11 to the RH chamber flange 312. To hermetically seal the connection of the RH plenum chamber 1 to the plurality of RH intake runners 31, a RH intake plenum gasket 4 is aligned and positioned in between the RH runner flange 11 and the RH chamber flange 312. The RH runner flange 11 and the RH chamber flange 312 are fastened and secured together by means of the fasteners 20. The LH plenum chamber 2 cups over the plurality of RH venturi stacks 13 and is connected to the plurality of LH intake runners 32 by the connection of the LH runner flange 21 to the LH chamber flange 322. Like the RH plenum chamber 1, a LH intake plenum gasket 5 is aligned and positioned in between the LH runner flange 21 and the RH chamber flange 312 to hermetically seal the connection. The LH runner flange 21 and the LH chamber flange 322 are fastened and secured together by means of the fasteners 20. The RH plenum chamber 1 is also connected to the LH plenum chamber 2 by means of a plenum chamber tube 40. The plenum chamber tube 40 connects the interior space of the RH plenum chamber 1 to the interior space of the LH plenum chamber 2. This connection allows even distribution of air density between the LH plenum chamber 2 and the RH plenum chamber 1. The even distribution of air density between the two plenum chambers provides every cylinder of the engine with equal amounts of air for consistent performance.

In reference to FIG. 1, the RH plenum chamber 1 and the LH plenum chamber 2 are able to suck in air by means of the at least one throttle body 6. In the preferred embodiment of the present invention, there is a throttle body for each of the plenum chambers. One throttle body is aligned to the RH intake opening 12 and the other is aligned to the LH intake opening 22. The two throttle bodies are secured to the RH plenum chamber 1 and the LH plenum chamber 2 by means of the fasteners 20. The throttle bodies serve as gates that allow air flow into the RH plenum chamber 1 and the LH plenum chamber 2. For air to enter the RH plenum chamber 1 and the LH plenum chamber 2, it must enter through the at least one throttle body 6.

In reference to FIG. 2-3, the fuel injection system makes use of the fuel rail brackets 10, the pair of fuel injector rails 9, the plurality of fuel injectors 7, and the fuel supply line 8. The fuel rail brackets 10 are fastened to and vertically extend from the runner manifold 3 adjacent to the RH cylinder flange 313 and the LH cylinder flange 323. The pair of fuel injector rails 9 is secured to the runner manifold 3 by means of the fuel rail bracket. The pair of fuel injector rails 9 is arranged with one fuel injector rail adjacent to the RH cylinder flange 313 and another fuel injector rail adjacent to the LH cylinder flange 323 in parallel relationship. The plurality of fuel injectors 7 are connected to the pair of fuel injector rails 9. The fuel injector rails 9 being connected to the fuel supply line 8 are able to supply the plurality of fuel injectors 7 with fuel. The number of fuel injectors corresponds to the number of cylinders in the engine. The plurality of fuel injectors 7 are fastened to the cylinder flange leading into the RH cylinder openings and the LH cylinder openings. The plurality of fuel injectors 7 are inserted and mounted to the cylinder flange in a perpendicular fashion with one end connected to the fuel injector rails 9. The RH cylinder flange 313 and the LH cylinder flange 323 are molded with a casting that provides a dock for each fuel injectors to allow it to be positioned and arranged vertically into each of the cylinder head of the engine.

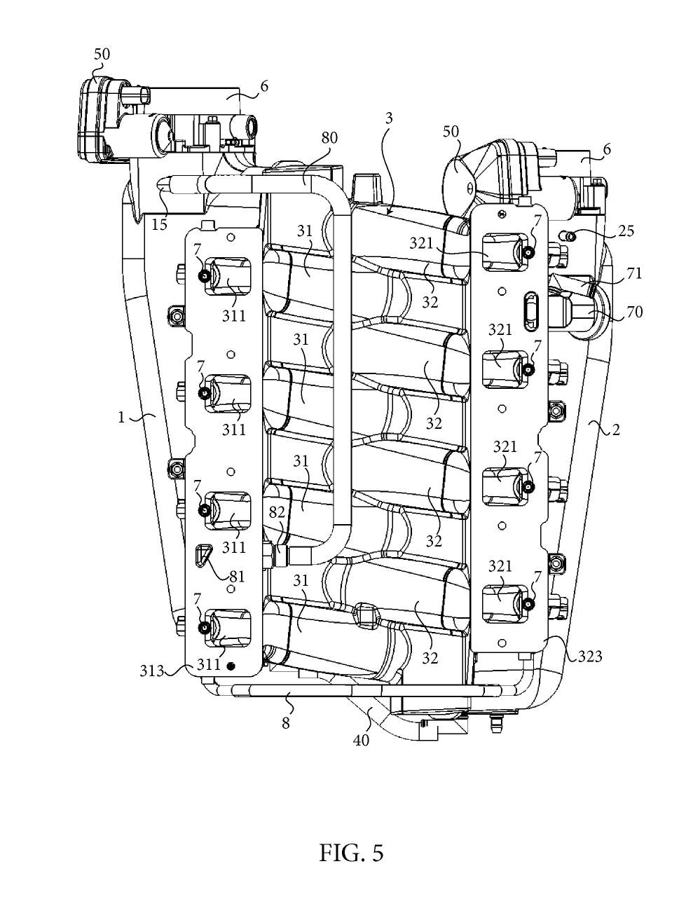

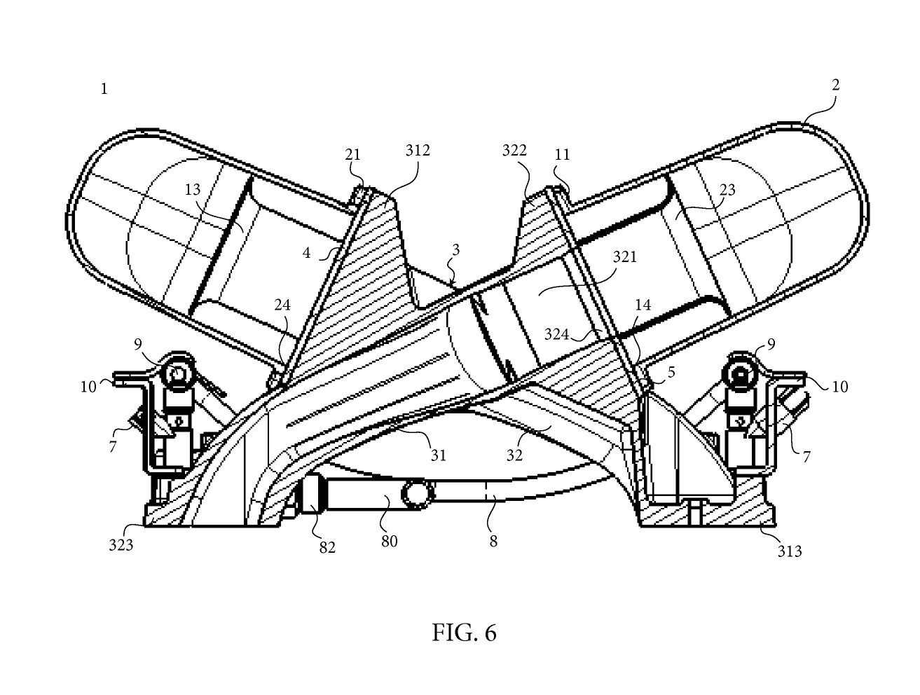

In reference to FIG. 5, the present invention can be integrated with peripheral piping that connects to other components of a car. To integrate the peripheral piping, the present invention additionally comprises a PCV connecting tube 80, a PCV channel 81, and a PCV valve 82. The RH plenum chamber 1 and the LH plenum chamber 2 further comprise a RH vacuum line nipple 15 and a LH vacuum line nipple 25, respectively. The RH vacuum line nipple 15 and the LH vacuum line nipple 25 are protrusions that lead into the RH plenum chamber 1 and the LH plenum chamber 2. The engine oil fill extension 70 is a funnel shaped structure that extends from the RH cylinder flange 313 and is positioned between two fuel injectors. The engine oil fill extension 70 comprises of a CCV vent 71. The CCV vent 71 extends from the side of the engine oil fill extension 70. The PCV connecting tube 80 and the PCV valve 82 are used to evacuate gasses from the crank casing. The gasses from the combustion chamber are able to leak past the piston into the crankcase. The amount is very small, but a buildup of pressure and other residues inside the crank case can lead a number of different problems. The PCV channel 81 is a hollow channel positioned on the RH cylinder flange 313 that leads into the crank shaft of an engine. Connected to the PCV channel 81 is the PCV valve 82. The PCV connecting tube 80 connects the PCV valve 82 to the RH vacuum line nipple 15. Additionally, to ensure that the present invention is injecting the proper fuel to air ratio into the cylinder heads a number of sensors are used for calculations. For each of the at least one throttle body 6, at least one mass flow sensor 50 are connected. On the rear of the RH backside, a manifold absolute pressure sensor 60 is attached to measure the air pressure inside the RH plenum chamber 1 and the LH plenum chamber 2. To connect the present invention onto the engine, the present invention comprises a plurality of cylinder head gaskets 30 to seal the runner manifold 3 onto each of the cylinder heads of the engine.

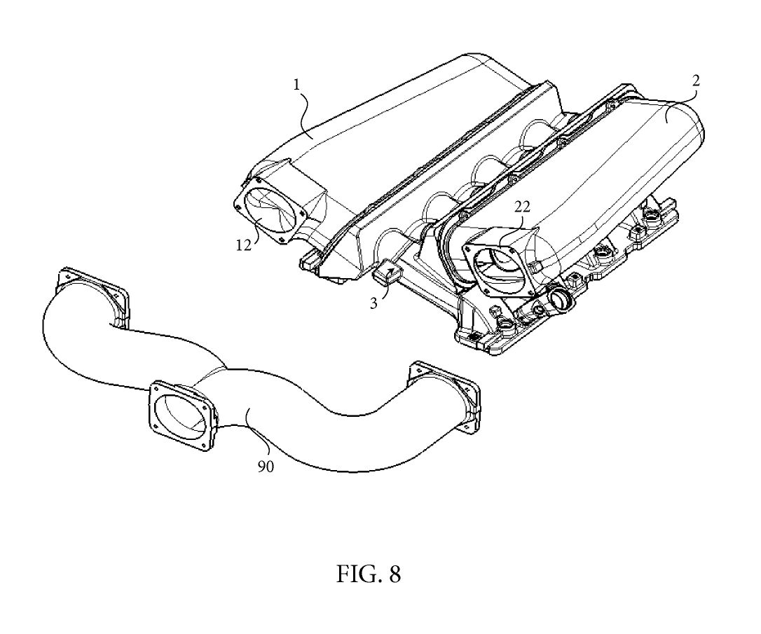

In reference to FIG. 8, the present invention can be configured to a different embodiment to achieve different performances. In this embodiment of the present invention, the present invention additionally comprises a Y-pipe 90. In this embodiment of the present invention, the configuration of the intake system is similar to the preferred embodiment. However, instead of the at least one throttle body 6 being aligned and connected to both the RH plenum chamber 1 and the LH plenum chamber 2, the Y-pipe 90 is aligned and connected to the RH plenum chamber 1 and the LH plenum chamber 2. The Y-pipe 90 comprises a two prong end and a one prong end. The Y-pipe 90 is connected to the RH plenum chamber 1 and the LH plenum chamber 2 by means of the two prong end being aligned and secure to the RH intake opening 12 and LH intake opening 22 by means of the fasteners 20. The Y-pipe 90 is able to connect and combine both the RH intake opening 12 and the LH intake opening 22 through the one prong end. In this embodiment of the present invention, the at least one throttle body 6 is aligned and secured to the one prong end. This allows both the RH plenum chamber 1 and the LH plenum chamber 2 to intake air through a common throttle body.

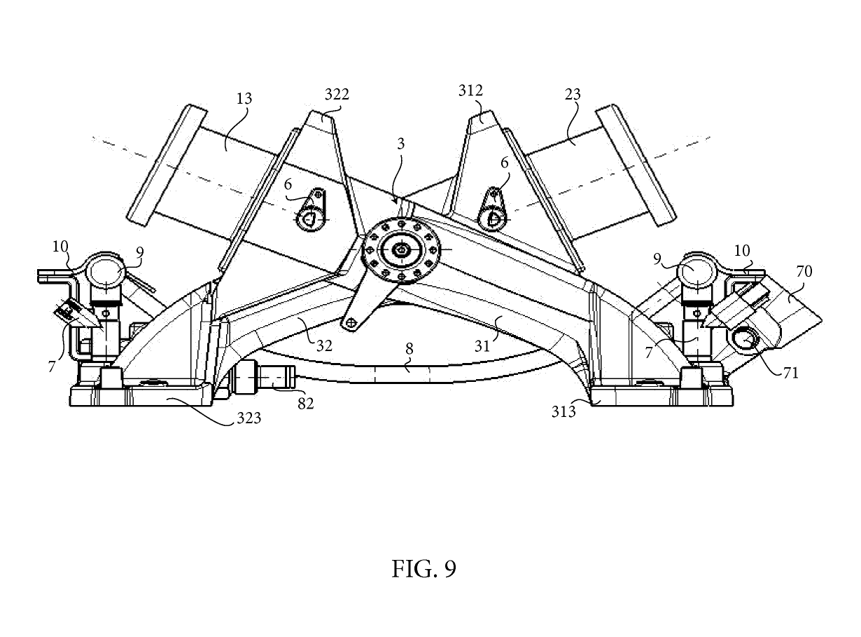

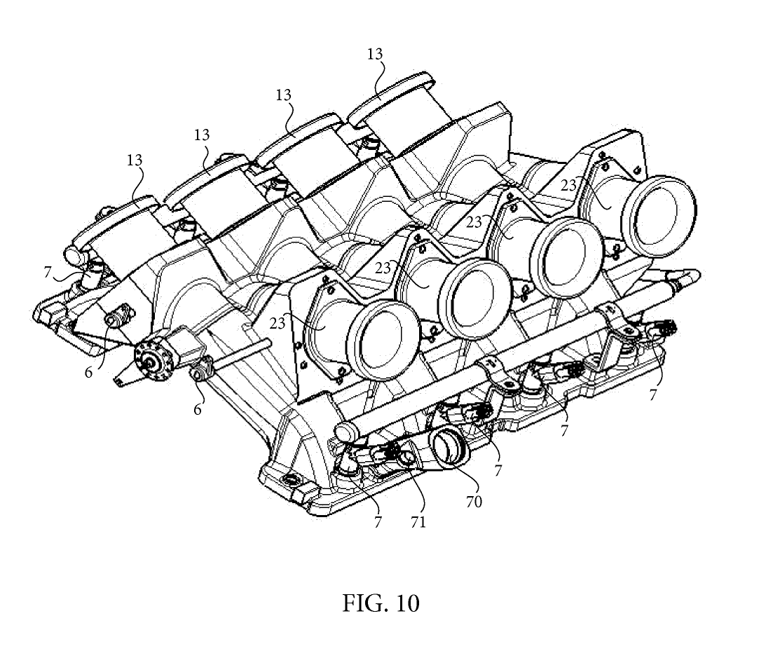

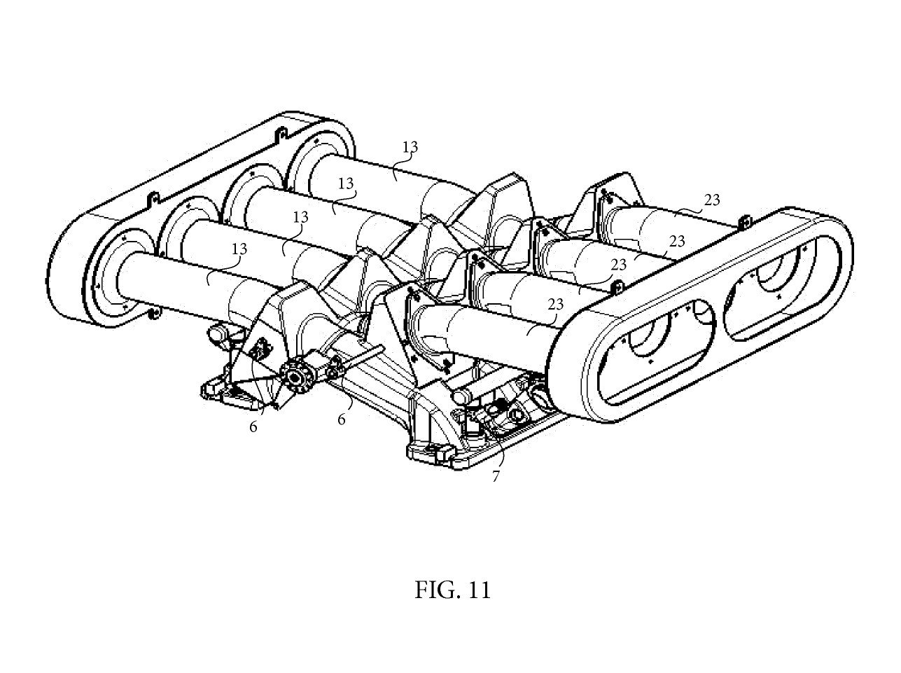

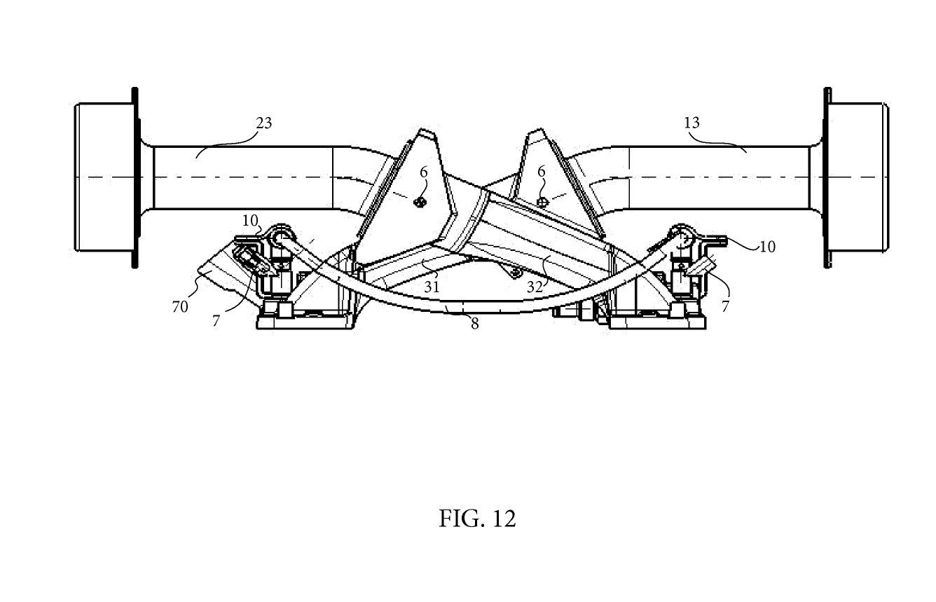

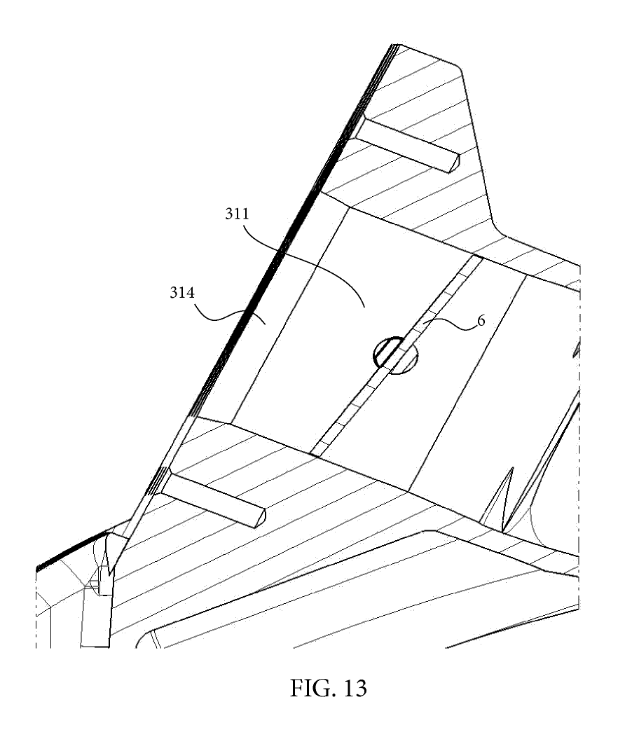

In reference to FIG. 9-13, another embodiment of the present invention involves a configuration of the intake manifold without the RH plenum chamber 1 and the LH plenum chamber 2. Instead, the intake system is able to suck air directly from the runners into the cylinders of an engine. In this embodiment of the present invention, the at least one throttle body 6 is positioned in line with the plurality of RH intake runners 31 and the plurality of LH intake runners 32. The at least one throttle body 6 is secured and sealed to the plurality of RH intake runners 31 and the plurality of LH intake runners 32 by means of the fasteners 20. In this embodiment of the present invention, the plurality of RH venturi stacks 13 and the plurality of LH venturi stacks 23 are directly connected to the plurality of RH runner channels 311 and the plurality of LH runner channels 321 of the runner manifold 3. The plurality of RH venturi stacks 13 and the plurality of LH venturi stacks 23 are connected and secured to the plurality of RH runner channels 311 and the plurality of LH runner channels 321 by the fasteners 20, respectively. The plurality of RH venturi stacks 13 and the plurality of LH venturi stacks 23 can be short or long as shown in FIG. 8 and FIG. 10. In this embodiment, the amount of space the present invention occupies is reduced and the air is directly vacuumed from the atmosphere. For each cylinder, there is a respective throttle body that allows air flow into the cylinders. All of the throttle bodies of the at least one throttle body 6 are controlled by a single serve motor to ensure the same amount of air is allowed into each of the cylinders. The combination of the venturi stacks provides the intake system to have the maximum amount of air flow through the piping towards the engine.

Although the invention has been explained in relation to its preferred embodiment, it is to be understood that many other possible modifications and variations can be made without departing from the spirit and scope of the invention as hereinafter claimed.

What is claimed is:

1. A modular cross-ram high performance intake manifold for V type multi-cylinder internal combustion engine comprises,
a RH plenum chamber;
a LH plenum chamber;
a runner manifold;
at least one throttle body;
a plurality of fuel injectors;
a fuel supply line;
fuel rail brackets;
a pair of fuel injector rails;
a plurality of cylinder head gaskets;
a plenum chamber tube;
at least one mass flow sensor;
a manifold absolute pressure sensor;
an engine oil fill extension;
the RH plenum chamber comprises a RH runner flange, a RH intake opening, a plurality of RH venturi stacks, and a RH runner opening;
the LH plenum chamber comprises a LH runner flange, a LH intake opening, a plurality of LH venturi stacks, and a LH runner opening;
the runner manifold comprises of a plurality of RH intake runners and a plurality of LH intake runners;
the RH plenum chamber having a RH front side, a RH back side, and a RH bottom side;
the LH plenum chamber having a LH front side, a LH back side, and a LH bottom side;
the RH plenum chamber being rounded and rectangular shaped;
the RH plenum chamber tapering towards the RH back side;
the LH plenum chamber being rounded and rectangular shaped;
the LH plenum chamber tapering towards the LH back side;
the plurality of RH intake runners being downwardly bending hollow tubes;
the plurality of LH intake runners being downwardly bending hollow tubes;
the plurality of RH intake runners comprises a RH chamber flange, a plurality of RH runner channels, a RH cylinder opening, a RH cylinder flange, and a plurality of RH intake runner stack openings; and
the plurality of LH intake runners comprises a LH chamber flange, a plurality of LH runner channels, a LH cylinder opening, a LH cylinder flange and a plurality of LH intake runner stack openings.

2. The modular cross-ram high performance intake manifold for V type multi-cylinder internal combustion engines as claimed in claim 1 comprises,
the RH plenum chamber being hollow;
the RH intake opening being positioned on the RH front side;
the RH runner flange being peripherally positioned on the RH bottom side;
the RH runner opening being positioned on the RH bottom side;
the plurality of RH venturi stacks being positioned inside the RH plenum chamber and being aligned to the plurality of RH runner stack openings;
the LH plenum being hollow;
the LH intake opening being positioned on the LH front side;
the LH runner flange being peripherally positioned on the LH bottom side;
the LH runner opening being positioned on the LH bottom side; and
the plurality of LH venturi stacks being positioned inside the LH plenum chamber and being aligned to the plurality of LH runner stack openings.

3. The modular cross-ram high performance intake manifold for V type multi-cylinder internal combustion engines as claimed in claim 1 comprises,
the plurality of RH intake runners and the plurality of LH intake runners being connected and arranged in an alternating crisscross fashion;
the plurality of RH intake runners having first RH ends and second RH ends;
the plurality of LH intake runners having first LH ends and second LH ends;
the RH chamber flange being positioned on the first RH ends;
the LH chamber flange being positioned on the first LH ends;
the plurality of RH runner channels being a funnel shaped channel traversing through the first RH ends;
the plurality of LH runner channels being a funnel shaped channel traversing through the first LH ends;
the RH cylinder flange being positioned on the second RH ends;
the LH cylinder flange being positioned on the second LH ends;
the plurality of RH intake runner stack openings leading into the plurality of RH runner channels; and
the plurality of LH intake runner stack openings leading into the plurality of LH runner channels.

4. The modular cross-ram high performance intake manifold for V type multi-cylinder internal combustion engines as claimed in claim 1 comprises,
the RH plenum chamber being connected to the plurality of RH intake runners by the connection of the RH runner flange to the RH chamber flange;
the LH plenum chamber being connected to the plurality of LH intake runners by the connection of the LH runner flange to the LH chamber flange;
a RH intake plenum gasket hermetically sealing the connection of the RH plenum chamber and the plurality of RH intake runners by being aligned and positioned in between the RH runner flange and the RH chamber flange;
a LH intake plenum gasket hermetically sealing the connection of the LH plenum chamber and the plurality of LH intake runners by being aligned and positioned in between the LH runner flange and the LH chamber flange;
the plurality of RH venturi stacks being connected to the plurality of RH intake runner stack openings by the fasteners;
the plurality of LH venturi stacks being connected to the plurality of LH intake runner stack openings by the fasteners;
the RH runner flange and the RH chamber flange being fastened together by means of the fasteners;
the LH runner flange and the LH chamber flange being fastened together by means of the fasteners; and
the RH plenum chamber being connected to the LH plenum chamber by means of the plenum chamber tube.

5. The modular cross-ram high performance intake manifold for V type multi-cylinder internal combustion engines as claimed in claim 4 comprises,
the at least one throttle body being aligned to the RH intake opening and the LH intake opening; and
the at least one throttle body being secured to the RH plenum chamber and the LH plenum chamber by means of the fasteners.

6. The modular cross-ram high performance intake manifold for V type multi-cylinder internal combustion engines as claimed in claim 4 comprises,
the fuel rail brackets being fastened to the runner manifold adjacent to the RH cylinder flange and the LH cylinder flange;
the pair of fuel injector rails being secured by the fuel rail bracket and arranged adjacent to the RH cylinder flange and the LH cylinder flange in parallel relationship;
the plurality of fuel injectors being connected to the pair of fuel injector rails;
the plurality of fuel injectors being fastened to the RH cylinder flange and the LH cylinder flange leading into the RH cylinder openings and the LH cylinder openings;
the pair of fuel injector rails being connected to the fuel supply line; and
the cylinder head gaskets being connected to the cylinder openings.

7. The modular cross-ram high performance intake manifold for V type multi-cylinder internal combustion engines as claimed in claim 4 comprises,
a PCV connecting tube;
a PCV channel;
a PCV valve;
the engine oil fill extension being extended from the RH cylinder flange;
the engine oil fill extension comprises a CCV vent;
the RH plenum chamber comprises a RH vacuum line nipple;
the LH plenum chamber comprises a LH vacuum line nipple;
the PCV channel being a hole traversing through the RH cylinder flange;
the at least one mass flow sensor being connected to the at least one throttle body;
the manifold absolute pressure sensor being attached to the RH back side;
the PCV connecting tube being connected to the PCV channel by means of the PCV valve;
the PCV connecting tube being connected to the RH vacuum line nipple;
the engine oil fill extension being connected and extended from the LH cylinder flange; and
the CCV vent extending from the engine oil fill extension.

8. A modular cross-ram high performance intake manifold for V type multi-cylinder internal combustion engine comprises,
a RH plenum chamber;
a LH plenum chamber;
a runner manifold;
at least one throttle body;
a plurality of fuel injectors;
a fuel supply line;
a fuel rail brackets;
a pair of fuel injector rails;
a plurality of cylinder head gaskets;
a plenum chamber tube;
a RH mass flow sensor;
a LH mass flow sensor;
a manifold absolute pressure sensor;
an engine oil fill extension;
the RH plenum chamber comprises a RH runner flange, a RH intake opening, a plurality of RH venturi stacks, and a RH runner opening;
the LH plenum chamber comprises a LH runner flange, a LH intake opening, a plurality of LH venturi stacks, and a LH runner opening;
the runner manifold comprises of a plurality of RH intake runners and a plurality of LH intake runners;
the RH plenum chamber having a RH front side, a RH back side, and a RH bottom side;
the LH plenum chamber having a LH front side, a LH back side, and a LH bottom side;
the RH plenum chamber being rounded and rectangular shaped;
the RH plenum chamber tapering towards the RH back side;
the LH plenum chamber being rounded and rectangular shaped;
the LH plenum chamber tapering towards the LH back side;
the plurality of RH intake runners being downwardly bending hollow tubes;
the plurality of LH intake runners being downwardly bending hollow tubes;
the plurality of RH intake runners comprises a RH chamber flange, a plurality of RH runner channel, a RH cylinder opening, a RH cylinder flange, and a plurality of RH intake runner stack openings; and
the plurality of LH intake runners comprises a LH chamber flange, a LH runner channel, a LH cylinder opening, a LH cylinder flange and a plurality of LH intake runner stack openings.

9. The modular cross-ram high performance intake manifold for V type multi-cylinder internal combustion engines as claimed in claim 8 comprises,
the RH plenum chamber being hollow;
the RH intake opening being positioned on the RH front side;
the RH runner flange being peripherally positioned on the RH bottom side;
the RH runner opening being positioned on the RH bottom side;
the plurality of RH venturi stacks being positioned inside the RH plenum chamber and being aligned to the plurality of RH runner stack openings;
the LH plenum being hollow;
the LH intake opening being positioned on the LH front side;
the LH runner flange being peripherally positioned on the LH bottom side;
the LH runner opening being positioned on the LH bottom side; and
the plurality of LH venturi stacks being positioned inside the LH plenum chamber and being aligned to the plurality of LH runner stack openings.

10. The modular cross-ram high performance intake manifold for V type multi-cylinder internal combustion engines as claimed in claim 8 comprises,
the plurality of RH intake runners and the plurality of LH intake runners being connected and arranged in an alternating crisscross fashion;
the plurality of RH intake runners having first RH ends and second RH ends;
the plurality of LH intake runners having first LH ends and second LH ends;
the RH chamber flange being positioned on the first RH ends;
the LH chamber flange being positioned on the first LH ends;
the plurality of RH intake runner stack openings leading into the plurality of RH runner channels;
the plurality of LH intake runner stack openings leading into the plurality of LH runner channels;
the RH cylinder flange being positioned on the second RH ends;
the LH cylinder flange being positioned on the second LH ends;
the plurality of RH intake runner stack openings leading into the plurality of RH runner channels; and
the plurality of LH intake runner stack openings leading into the plurality of LH runner channels.

11. The modular cross-ram high performance intake manifold for V type multi-cylinder internal combustion engines as claimed in claim 8 comprises,
the RH plenum chamber being connected to the plurality of RH intake runners by the connection of the RH runner flange to the RH chamber flange;
the LH plenum chamber being connected to the plurality of LH intake runners by the connection of the LH runner flange to the LH chamber flange;
the RH intake plenum gasket hermetically sealing the connection of the RH plenum chamber and the plurality of RH intake runners by being aligned and positioned in between the RH runner flange and the RH chamber flange;
the LH intake plenum gasket hermetically sealing the connection of the LH plenum chamber and the plurality of LH intake runners by being aligned and positioned in between the LH runner flange and the LH chamber flange;
the plurality of RH venturi stacks being connected to the plurality of RH intake runner stack openings by the fasteners;
the plurality of LH venturi stacks being connected to the plurality of LH intake runner stack openings by the fasteners;
the RH runner flange and the RH chamber flange being fastened together by means of the fasteners;
the LH runner flange and the LH chamber flange being fastened together by means of the fasteners; and
the RH plenum chamber being connected to the LH plenum chamber by means of the plenum chamber tube.

12. The modular cross-ram high performance intake manifold for V type multi-cylinder internal combustion engines as claimed in claim 11 comprises,
a Y-pipe;
the Y-pipe having a two prong end and a one prong end;
the Y-pipe being connected to the RH plenum chamber and the LH plenum chamber by means of the two prong end being aligned and secured to the RH intake opening and LH intake opening by means of the fasteners;
the at least one throttle body being aligned to the one prong end; and
the at least one throttle body being secured to the Y-pipe by means of the fasteners.

13. The modular cross-ram high performance intake manifold for V type multi-cylinder internal combustion engines as claimed in claim 11 comprises,
the fuel rail brackets being fastened to the runner manifold adjacent to the RH cylinder flange and the LH cylinder flange;
the pair of fuel injector rails being secured by the fuel rail bracket and arranged adjacent to the RH cylinder flange and the LH cylinder flange in parallel relationship;
the plurality of fuel injectors being connected to the pair of fuel injector rails;
the plurality of fuel injector being fastened to the RH cylinder flange and the LH cylinder flange leading into the RH cylinder openings and the LH cylinder openings;
the pair of fuel injector rails being connected to the fuel supply line; and
the cylinder head gaskets being connected to the cylinder openings.

14. The modular cross-ram high performance intake manifold for V type multi-cylinder internal combustion engines as claimed in claim 11 comprises,
a PCV connecting tube;
a PCV channel;
a PCV valve;
the engine oil fill extension comprises a CCV vent;
the RH plenum chamber comprises a RH vacuum line nipple;
the LH plenum chamber comprises a LH vacuum line nipple;
the PCV channel being a hole traversing through the RH cylinder flange;
the at least one mass flow sensor being connected to the at least one throttle body;
the manifold absolute pressure sensor being attached to the RH back side;
the PCV connecting tube being connected to the PCV channel by means of the PCV valve;
the PCV connecting tube being connected to the RH vacuum line nipple;
the engine oil fill extension being connected and extended from the LH cylinder flange; and
the CCV vent extending from the engine oil fill extension.

15. A modular cross-ram high performance intake manifold for V type multi-cylinder internal combustion engine comprises,
a runner manifold;
at least one throttle body;
a plurality of fuel injectors;
a fuel supply line;
a fuel rail brackets;
a pair of fuel injector rails;
a plurality of cylinder head gaskets;
at least one mass flow sensor;
an engine oil fill extension;
a plurality of RH venturi stacks;
a plurality of LH venturi stacks;
the runner manifold comprises of a plurality of RH intake runners and a plurality of LH intake runners;
the plurality of RH intake runners being downwardly bending hollow tubes;
the plurality of LH intake runners being downwardly bending hollow tubes;
the plurality of RH intake runners comprises a plurality of RH runner channel, a RH cylinder opening, and a RH cylinder flange; and
the plurality of LH intake runners comprises a plurality of LH runner channel, a LH cylinder opening, and a LH cylinder flange.

16. The modular cross-ram high performance intake manifold for V type multi-cylinder internal combustion engines as claimed in claim 15 comprises,
the RH intake runners and the LH intake runners being connected and arranged in an alternating crisscross fashion;
the plurality of RH intake runners having first RH ends and second RH ends;
the plurality of LH intake runners having first LH ends and second LH ends;
the RH chamber flange being positioned on the first RH ends;
the LH chamber flange being positioned on the first LH ends;
the plurality of RH runner channels being a funnel shaped channel traversing through the first RH ends;
the plurality of LH runner channels being a funnel shaped channel traversing through the first LH ends;
the RH cylinder flange being positioned on the second RH ends; and
the LH cylinder flange being positioned on the second LH ends.

17. The modular cross-ram high performance intake manifold for V type multi-cylinder internal combustion engines as claimed in claim 16 comprises,
the at least one throttle body being positioned in line with the plurality of RH intake runners and the plurality of LH intake runners; and
the at least one throttle body being secured and sealed to the plurality of RH intake runners and the plurality of LH intake runners by means of the fasteners.

18. The modular cross-ram high performance intake manifold for V type multi-cylinder internal combustion engines as claimed in claim 17 comprises,
the plurality of RH venturi stacks being connected and secured to the plurality of RH runner channels by the fasteners; and
the plurality of LH venturi stacks being connected and secured to the plurality of LH runner channels by the fasteners.

19. The modular cross-ram high performance intake manifold for V type multi-cylinder internal combustion engines as claimed in claim 17 comprises,
the fuel rail brackets being fastened to the runner manifold adjacent to the RH cylinder flange and the LH cylinder flange;
the pair of fuel injector rails being secured by the fuel rail bracket and arranged adjacent to the RH cylinder flange and the LH cylinder flange in parallel relationship;
the plurality of fuel injectors being connected to the pair of fuel injector rails;
the plurality of fuel injector being fastened to the RH cylinder flange and the LH cylinder flange leading into the RH cylinder openings and the LH cylinder openings;
the pair of fuel injector rails being connected to the fuel supply line; and
the cylinder head gaskets being connected to the cylinder openings.

20. The modular cross-ram high performance intake manifold for V type multi-cylinder internal combustion engines as claimed in claim 17 comprises,
a PCV connecting tube;
a PCV channel;
a PCV valve;
the engine oil fill extension comprises a CCV vent;
the PCV channel being a hole traversing through the RH cylinder flange;
the at least one mass flow sensor being connected to the at least one throttle body;
the manifold absolute pressure sensor being attached to the RH back side;
the PCV connecting tube being connected to the PCV channel by means of the PCV valve;
the PCV connecting tube being connected to the RH vacuum line nipple;
the engine oil fill extension being connected and extended from the LH cylinder flange; and
the CCV vent extending from the engine oil fill extension.
